(19) United States
(12) Patent Application Publication
(10) Pub. No.: US 2015/0007904 A1
(43) Pub. Date: Jan. 8, 2015

(54) ABRASION RESISTANT WELDED STEEL PIPE AND METHOD OF PRODUCING THE SAME

(71) Applicant: JFE Steel Corporation, Chiyoda-ku, Tokyo (JP)

(72) Inventors: Akihiko Tanizawa, Tokyo (JP); Mitsuhiro Okatsu, Tokyo (JP); Keiji Ueda, Tokyo (JP); Kimihiro Nishimura, Tokyo (JP); Shinji Mitao, Tokyo (JP)

(73) Assignee: JFE Steel Corporation, Chiyoda-ku, Tokyo (JP)

(21) Appl. No.: 14/371,346

(22) PCT Filed: Jan. 8, 2013
(86) PCT No.: PCT/JP2013/050063

§ 371 Date: Jul. 9, 2014

(30) Foreign Application Priority Data
Jan. 10, 2012 (JP) 2012-001769

(51) Int. Cl. F16L 9/17; B23K 25/00; B23K 9/025; F16L 9/02; B21B 3/02

(52) U.S. Cl. CPC F16L 9/17; F16L 9/02; B21B 3/02; B23K 9/0253; B23K 25/00
USPC 138/171; 138/177; 72/369; 219/61; 219/73.1

(57) ABSTRACT

In an abrasion resistant welded steel pipe, each of a base material and a weld metal contains specific amounts of chemical composition. The base material of the abrasion resistant welded steel pipe has a Vickers hardness within the range of 150 to 250, and the weld metal has a Vickers hardness within the range of 230 to 350. A weld heat affected zone in the abrasion resistant welded steel pipe has a Vickers hardness within the range of 150 to 350. In the weld metal, the dispersion density of a sulfide having an aspect ratio of 5 or more and containing at least one selected from Fe, Mn, and Ti is 10 grains/mm² or less. The abrasion resistant welded steel pipe that can be produced at high productivity and low cost with no reduction in weld crack resistance can be provided.

### FIELD

The present invention relates to welded steel pipes used for piping for transporting a transportation object and to a method of producing the same. Particularly, the present invention relates to an abrasion resistant welded steel pipe having high weld crack resistance and used for a portion in which abrasion by impingement of the transportation object is a problem and to a method of producing the same.

### BACKGROUND

In piping used to transport a transportation object such as gravel or coal combustion ash, the thickness of the piping is reduced over time due to abrasion by impingement of the transportation object. The piping must be replaced when the amount of reduction in thickness becomes equal to or larger than a certain value, and this causes problems such as the cost of the material of the substituted pipes, their construction cost, and a reduction in transportation volume and production volume that is caused by shutdown of a pipeline or a plant during replacement. Therefore, it is desirable to use, for the piping, welded steel pipes which are not reduced in thickness by abrasion by impingement or in which, even when a reduction in thickness occurs, the rate of reduction in thickness is low.

It is known that there is a close correspondence between the abrasion resistance of a steel pipe and its hardness. However, when the hardness of the steel pipe material is increased, its cold workability is significantly impaired, and it is therefore difficult to produce welded steel pipes using a high-efficiency pipe-making process such as a UOE process or a press-bending process. For this reason, high-hardness abrasion resistant steel plates developed for construction and industrial machinery fields cannot be generally used as steel pipe materials as they are.

When a large amount of alloy elements such as C is added in order to increase the hardness of a steel pipe, weldability deteriorates, and pre-heating or post-heating at high temperature is required when seam welding is performed to produce a welded steel pipe. When the hardness of a steel pipe is made high, weld cracking occurs, and the frequency of repair of cracked portions increases, so that a reduction in productivity is inevitable. Therefore, abrasion resistant steel pipes must have contradictory properties such as abrasion resistance, cold workability, and weldability.

In regard to the above, Patent Literature 1 discloses a method for ensuring excellent abrasion resistance. In this method, the content of Si in a steel pipe material is set within the range of 0.5% to 2.0%, and, after a steel pipe is formed, it is heated into a two-phase region and then subjected to quenching treatment. Patent Literature 2 discloses a method of producing a bent steel pipe in which excellent abrasion resistance is ensured. In this method, the content of Si in a steel pipe material is set within the range of 0.5% to 2.0%, and, after a steel pipe is formed, it is heated into a two-phase region and then subjected to bending.

Patent Literature 3 discloses a method of allowing a welded steel pipe to have both abrasion resistance and weldability. In this method, the welded steel pipe is produced by a method similar to that in any of Patent Literatures 1 and 2, and the hardness of the welded steel pipe is set to a value from 200 to 350. Patent Literature 4 discloses a method of allowing a seamless steel pipe to have both excellent abrasion resistance and toughness. In this method, the content of Si in a steel pipe material is set within the range of 0.5% to 2.0%, and the seamless steel pipe is heated into a two-phase region and then subjected to two-stage cooling.

Patent Literatures 5 to 7 disclose methods of ensuring the abrasion resistance of the inner surface of a steel pipe. In this method, the content of C in a steel pipe material is set within the range of 0.4% to 0.5%, and after a steel pipe is formed, the steel pipe is heated, and then the inner surface of the steel pipe is subjected to water quenching. Patent Literature 8 discloses a method of ensuring the abrasion resistance of the inner surface of a seamless steel pipe. In this method, after the steel pipe is hot-rolled, its inner surface is water-cooled with ferrite transformation completed on the outer surface and uncompleted on the inner surface.

Patent Literature 9 discloses a method of ensuring abrasion resistance. In this method, a multilayer slab formed using low-alloy steel and molten alloy steel having higher hardenability is used. After a steel pipe is formed, the steel pipe is heated, and then only its inner surface is cooled. Patent Literature 10 discloses a method of ensuring abrasion resistance. In this method, a slab similar to that in Patent Literature 9 is used. After the slab is hot-rolled, the side formed from the molten alloy steel is water-cooled. In methods disclosed in Patent Literatures 11 and 12, a multilayer slab is used. To ensure abrasion resistance, the content of C in an outer layer of the steel pipe material is set within the range of 0.2% to 0.6%. To ensure other properties, the content of C in an inner layer is set within the range of 0.01% to 0.30%.

Patent Literature 13 discloses a method of ensuring the abrasion resistance of a welded portion of the innermost layer of a clad steel pipe and the soundness of other welded portions. In this method, high-carbon steel is used as an inner clad material of the clad steel pipe, and overlay using a welding material containing a larger amount of C than the clad material is performed at least in a welding pass on the innermost layer during seam welding.

Patent Literature 14 discloses a method of ensuring the abrasion resistance of a portion of a steel pipe that comes into contact with a slurry. In this method, the steel pipe is formed by welding ends of a plurality of arc-shaped steel plates with different degrees of ease of abrasion by a slurry. Patent Literature 15 discloses a method of ensuring the abrasion resistance of a portion of a steel pipe that comes into contact with a slurry. In this method, the steel pipe is formed by welding ends of a plurality of arc-shaped steel plates with different thicknesses. Patent Literature 16 discloses a method of ensuring the abrasion resistance of the inner surface of a steel pipe. In this method, the steel pipe is lined with a crystallized material including slag as a main raw material.

### CITATION LIST

### Patent Literature

Patent Literature 1: Japanese Patent Application Laid-open No. 6-220534
Patent Literature 2: Japanese Patent Application Laid-open No. 6-158163
Patent Literature 3: Japanese Patent Application Laid-open No. 7-90489
Patent Literature 4: Japanese Patent Application Laid-open No. 9-184014
Patent Literature 5: Japanese Patent Application Laid-open No. 8-295934
Patent Literature 6: Japanese Patent Application Laid-open No. 8-295988
Patent Literature 7: Japanese Patent Application Laid-open No. 8-295989
Patent Literature 8: Japanese Patent Application Laid-open No. 1-234520
Patent Literature 9: Japanese Patent Application

Laid-open No. 4-52026
Patent Literature 10: Japanese Patent Application Laid-open No. 4-56726
Patent Literature 11: Japanese Patent Application Laid-open No. 5-98351
Patent Literature 12: Japanese Patent Application Laid-open No. 5-98390
Patent Literature 13: Japanese Patent Application Laid-open No. 10-8191
Patent Literature 14: Japanese Patent Application

Laid-open No. 62-220215
Patent Literature 15: Japanese Patent Application Laid-open No. 62-220217
Patent Literature 16: Japanese Patent Application Laid-open No. 50-48519

### SUMMARY

### Technical Problem

However, with any of the methods disclosed in Patent Literatures 1 to 4, the steel pipe must be heated into a two-phase region and then quenched. Therefore, problems with these methods are that an apparatus for quenching the steel pipe is required and that the quenching causes a reduction in roundness of the steel pipe and also causes a reduction in production efficiency. The abrasion resistance can also be ensured by subjecting the steel pipe material to heat treatment in the two-phase region. However, in this case, the strength becomes too high, and it is therefore difficult to form the steel pipe material into a steel pipe shape by cold working.

The methods disclosed in Patent Literatures 5 to 7 are slightly simpler than the methods disclosed in Patent Literatures 1 to 4 because the steel pipe as a whole is not subjected to heat treatment, and the roundness can be easily ensured. However, with these methods, the inner surface of the steel pipe must be subjected to quenching. Therefore, problems with these methods are that an apparatus for quenching the inner surface of the steel pipe is required and that the production efficiency is reduced. When the hardness of only the inner surface of a steel pipe is increased, the rate of reduction in thickness of the steel pipe becomes non-uniform, and its remaining life is difficult to estimate. To ensure abrasion resistance by quenching the inner surface, the content of C in the steel pipe material must be made high, and this causes a problem in that weldability is reduced. The method disclosed in Patent Literature 8 utilizes the difference in cooling rate between the inner and outer surfaces of the seamless steel pipe after hot rolling, and it is difficult to apply this method to a welded steel pipe.

In any of the methods disclosed in Patent Literatures 9 to 13, a multilayer slab or a clad is used, and the production of the multilayer slab or clad is very costly. In the methods disclosed in Patent Literatures 14 and 15, arc-shaped plates must be produced, and at least two seam-welded portions are necessary. Therefore, a problem with these methods is their productivity. Moreover, for a pipeline for pressure-feeding of fine powder such as coal combustion ash, the entire inner surface of the steel pipe wears, so that these methods are not effective.

The method disclosed in Patent Literature 16 is an example of a method of lining the inner surface of a steel pipe with an abrasion resistant material. However, the lining of the inner surface of the steel pipe is not effective means because the production cost increases significantly. Lining of a steel pipe with urethane etc. is generally performed, but this is not effective means from the viewpoint of the production cost.

As described above, the conventional techniques result in an increase in cost, a reduction in productivity, a deterioration in weldability, and a deterioration in formability and require a special apparatus. With these techniques, it is difficult to produce a welded steel pipe having excellent abrasion resistance with no deterioration in these properties.

The present invention has been made in view of the foregoing problems, and it is an object thereof to provide an abrasion resistant welded steel pipe that can be produced at low cost and high productivity with no reduction in weld crack resistance and to provide a method of producing the welded steel pipe.

### Solution to Problem

An abrasion resistant welded steel pipe according to the present invention is an abrasion resistant welded steel pipe having excellent weld crack resistance and produced by cold-working a thick steel plate into a tubular shape and subjecting the resultant thick steel plate to butt welding, wherein a base material of the abrasion resistant welded steel pipe is formed of chemical composition including, in terms of percent by mass, C: 0.05% or more and less than 0.40%, Si: 0.05% or more and less than 0.5%, Mn: 0.1% or more and 2.0% or less, P: 0.03% or less, S: 0.01% or less, Al: 0.1% or less, and Ti: 0.1% or more and 1.2% or less and further including at least one selected from Cu: 0.1% or more and 1.0% or less, Ni: 0.1% or more and 2.0% or less, Cr: 0.1% or more and 1.0% or less, Mo: 0.05% or more and 1.00% or less, W: 0.05% or more and 1.00% or less, and B: 0.0003% or more and 0.0030% or less, with the balance being Fe and unavoidable impurities, Ceq represented by the following formula (1) being 0.55 or less, DI* represented by the following formula (2) being less than 60, a weld metal of the abrasion resistant welded steel pipe is formed of chemical composition including, in terms of percent by mass, C: 0.05% or more and less than 0.30%, Si: 0.05% or more and less than 0.50%, Mn: 0.1% or more and 2.0% or less, P: 0.03% or less, S: 0.01% or less, Al: 0.1% or less, Ti: 0.05% or more and 1.2% or less, N: 0.008% or less, and O: 0.02% or more and 0.08% or less and further including at least one selected from Cu: 0.1% or more and 1.0% or less, Ni: 0.1% or more and 2.0% or less, Cr: 0.1% or more and 1.0% or less, Mo: 0.05% or more and 1.00% or less, W: 0.05% or more and 1.00% or less, and B: 0.0003% or more and 0.0030% or less, with the balance being Fe and unavoidable impurities, Ceq represented by the following formula (1) being 0.55 or less, UCS represented by the following formula (3) being less than 42, PTI represented by the following formula (4) being 0 or more, the base material of the abrasion resistant welded steel pipe has a Vickers hardness within a range of 150 to 250, the weld metal has a Vickers hardness within a range of 230 to 350, and a weld heat affected zone in the abrasion resistant welded steel pipe has a Vickers hardness within a range of 150 to 350, and in the weld metal, the dispersion density of a sulfide having an aspect ratio of 5 or more and containing at least one selected from Fe, Mn, and Ti is 10 grains/mm² or less.

Ceq=C+Mn/6+(Cu+Ni)/15+(Cr+Mo+V)/5, (1)

DI*=33.85×(0.1×C*)^{0.5}×(0.7×Si+1)×(3.33×Mn+1)×(0.35×Cu+1)×(0.36×Ni+1)×(2.16×Cr+1)×(3×Mo*+1)×(1.5×W*+1), (2)

where C*=C−¼×(Ti−48/14×N), Mo*=Mo×[1−0.5×(Ti−48/14×N)], and W*=W×[1−0.5×(Ti−48/14×N)],

UCS=230×C−12.3×Si−5.4×Mn+75×P+190×S−14×Al+45×Nb−1, and (3)

PTI=Ti−1.5×(O−0.89×Al)−3.4×N−4.5×S, (4)

wherein symbols of elements on the right-hand side of each formula represent contents of the elements (% by mass), respectively, and a content of an element not contained is set to 0.

In the abrasion resistant welded steel pipe according to the present invention, the chemical composition of at least one of the base material and the weld metal of the abrasion resistant welded steel pipe include, in terms of percent by mass, at least one selected from Nb: 0.005% or more and 1.000% or less and V: 0.005% or more and 1.000% or less.

In the abrasion resistant welded steel pipe according to the present invention, the base material of the abrasion resistant welded steel pipe has a metallographic structure including: a matrix structure including a ferrite structure and a pearlite structure; and a hard phase dispersed in the matrix structure.

In the abrasion resistant welded steel pipe according to the present invention, a dispersion density of the hard phase is 400 grains/mm² or more.

A method of producing the abrasion resistant welded steel pipe according to the present invention, in producing the abrasion resistant welded steel pipe according to the present invention, including hot-rolling a slab and thereafter cooling the hot-rolled slab to 400° C. or lower at a cooling rate of 2° C./s or less to produce a thick steel plate; cold-working the thick steel plate into a tubular shape; and subjecting the resultant thick steel plate to butt welding.

In the method of producing the abrasion resistant welded steel pipe according to the present invention, the butt welding is performed by submerged arc welding.

### Advantageous Effects of Invention

According to the present invention, an abrasion resistant welded steel pipe that can be produced at low cost and high productivity with no reduction in weld crack resistance can be provided, and a method of producing the welded steel pipe can also be provided.

### DESCRIPTION OF EMBODIMENTS

The present inventors have conducted studies with attention focused on the chemical composition, metallographic structure, and hardness of each of a steel pipe material and a weld metal, the form of dispersion of a precipitate therein, etc. and have obtained the findings described below. In the following description, the steel pipe material means a steel plate for producing a welded steel pipe. This steel plate is formed into a tubular shape by cold working such as UOE or press-bending, and the edges of the resultant plate are butt-welded to produce a welded steel pipe. The welded steel pipe includes the weld metal, a weld heat affected zone, and a base material other than these. Specifically, the properties of the steel pipe material can be considered to be substantially the same as those of the base material of the welded steel pipe. Therefore, in the following description, when the properties of a steel material are described, the steel material is referred to as a “steel pipe material” mainly before welding and as “the base material of the welded steel pipe” or simply as “the base material of the steel pipe” or “the base material” after welding. When it is not necessary to distinguish them from each other, any of these terms may be appropriately used.

First, the present inventors have conducted studies on the relationships of the chemical composition and morphology of a steel pipe material to its abrasion resistance and bendability. As a result of the studies, the inventors have found that the bendability can be explained substantially unambiguously by the hardness of the steel pipe material but the abrasion resistance is influenced not only by the hardness but also by the form of dispersion of the precipitate. Specifically, a steel pipe base material in which relatively coarse precipitate crystals such as crystals crystallized when the steel material is in a molten state are uniformly dispersed in a matrix phase has significantly high abrasion resistance. Therefore, the present inventors have used a mixed structure of a soft ferrite structure and a pearlite structure (hereinafter may be referred to as a “ferrite+pearlite structure”) as the metallographic structure of the matrix phase. In this case, the hardness is reduced, and the bendability is thereby improved. In addition, the inventors have used chemical composition including Ti and C. In this case, a hard second phase such as TiC is uniformly dispersed in the matrix phase, and the abrasion resistance is thereby improved.

The use of the above steel pipe material allows production of a welded steel pipe having excellent abrasion resistance by cold working such as UOE or press-bending. Since TiC is dispersed in the steel pipe material of the present invention, the steel pipe material may contain a larger amount of C than ordinary low-carbon steel, so that an improvement in weldability during butt welding is an issue. The present inventors have further conducted studies with attention focused on the mechanism of occurrence of high-temperature cracking during welding and have found the following. When ordinary high-carbon steel is welded, S is concentrated on unsolidified portions during final solidification and forms FeS. The formed FeS is a film-shaped sulfide having low ductility and therefore causes cracking of the weld metal during cooling. Specifically, when a large amount of Ti is added, spherical TiS is precipitated. This can suppress formation of FeS, which is a film-shaped sulfide, to thereby reduce susceptibility to high-temperature cracking.

The present inventors have also found that, to form TiS during rapid solidification of the welded portion, the required amount of Ti is at least 3 times the mass percentage of S determined by the stoichiometric ratio. The present inventors have also found that susceptibility to low-temperature cracking can be reduced by controlling welding conditions and chemical composition such as the carbon equivalent to reduce the Vickers hardness to 350 or less.

The reasons for limitations on structural requirements in the present invention will next be described separately. In the following description, the unit of each chemical component is percent by mass, and the hardness is measured as Vickers hardness (Hv). In the following description, the base material of a welded steel pipe may be abbreviated as “steel pipe base material.”

### 1. Base Material of Welded Steel Pipe (Steel Pipe Base Material)

### 1.1 Chemical Composition of Steel Pipe Base Material

The reasons for limitations on the chemical composition of a steel pipe base material will first be described.

### [Content of C]

C is an effective element that improves the hardness of a matrix phase in a metallographic structure to thereby improve abrasion resistance and forms Ti carbide, which is a hard second phase (hereinafter may be referred to as a hard phase), to thereby improve the abrasion resistance. To obtain the above effect, the content of C must be 0.05% or more. When the content is 0.40% or more, the carbide, i.e., the hard phase, becomes coarse. In this case, not only cracks originating from the carbide occur during bending, but also the hardness of a weld heat affected zone increases during seam welding, so that susceptibility to low-temperature cracking increases. Therefore, the content of C is specified within the range of 0.05% or more and less than 0.40%. Preferably, the content of C is within the range of 0.15% or more and 0.35% or less.

### [Content of Si]

Si is an element effective as a deoxidizing element, and the content of Si must be 0.05% or more in order to achieve this effect. Si is also an effective element that forms a solid solution with the steel and contributes to an increase in hardness by solid solution strengthening. If the content is 0.5% or more, problems such as a reduction in ductility and toughness and an increase in the amount of inclusions occur. Therefore, the content of Si is limited within the range of 0.05% or more and less than 0.5%. Preferably, the content of Si is within the range of 0.05% or more and 0.40% or less.

### [Content of Mn]

Mn is an effective element that contributes to an increase in hardness by solid solution strengthening, and the content of Mn must be 0.1% or more in order to obtain this effect. If the content exceeds 2.0%, weldability deteriorates. Therefore, the content of Mn is limited within the range of 0.1% or more and 2.0% or less. Preferably, the content of Mn is within the range of 0.1% or more and 1.60% or less.

### [Content of P]

P is an impurity element, and the content of P is preferably as low as possible from the viewpoint of toughness of the steel pipe base material and the susceptibility of the weld metal to high-temperature cracking resistance. However, to reduce the content of P, the cost in a steel making process increases. Therefore, the allowable content of P is within the range of 0.03% or less.

### [Content of S]

S is an impurity element, and the content of S is preferably as low as possible from the viewpoint of the ductility of the steel pipe base material and the susceptibility of the weld metal to high-temperature cracking resistance. However, to reduce the content of S, the cost in the steel making process increases. Therefore, the allowable content of S is within the range of 0.01% or less.

### [Content of Al]

Al functions as a deoxidizer, and its effect is observed when the content of Al is 0.0020% or more. However, if the content is large, i.e., more than 0.1%, the cleanliness of the steel decreases. Therefore, the content of Al is limited within the range of 0.1% or less. Preferably, the content of Al is within the range of 0.0020% or more and 0.055% or less.

### [Content of Ti]

Ti, as well as C, is an important element in the present invention and is an essential element that forms Ti carbide, i.e., a hard phase, contributing to an improvement in abrasion resistance. The content of Ti must be 0.1% or more in order to obtain this effect. If the content of Ti exceeds 1.2%, the Ti-based carbide forming the hard phase is increased in size, and cracks originating from the coarse hard phase occur during bending. Therefore, the content of Ti is within the range of 0.1% or more and 1.2% or less. Preferably, the content of Ti is within the range of 0.1% or more and 0.8% or less.

In the present invention, at least one of the elements specified below may be selectively added, from the viewpoint of, for example, ensuring the strength of the steel pipe material.

### [Content of Cu]

Cu is an element that forms a solid solution and thereby improves hardenability, and the content of Cu must be 0.1% or more in order to obtain this effect. If the content exceeds 1.0%, hot-workability deteriorates. Therefore, when Cu is added, it is preferable to limit the content of Cu within the range of 0.1% or more and 1.0% or less. More preferably, the content of Cu is within the range of 0.1% or more and 0.5% or less.

### [Content of Ni]

Ni is an element that forms a solid solution and thereby improves hardenability, and this effect is significant when the content of Ni is 0.1% or more. If the content exceeds 2.0%, the material cost increases significantly. Therefore, when Ni is added, it is preferable to limit the content of Ni within the range of 0.1% or more and 2.0% or less. More preferably, the content of Ni is within the range of 0.1% or more and 1.0% or less.

### [Content of Cr]

Cr has the effect of improving hardenability, and the content of Cr must be 0.1% or more in order to obtain this effect. However, if the content exceeds 0.1%, weldability may deteriorate. Therefore, when Cr is added, it is preferable to limit the content of Cr within the range of 0.1% or more and 1.0% or less. More preferably, the content of Cr is within the range of 0.1% or more and 0.8% or less. Still more preferably, the content of Cr is within the range of 0.4% or more and 0.7% or less.

### [Content of Mo]

Mo is an element that improves hardenability. In order to obtain this effect, the content of Mo must be 0.05% or more. If the content exceeds 1.00%, weldability may deteriorate. Therefore, when Mo is added, it is preferable to limit the content of Mo within the range of 0.05% or more and 1.00% or less. More preferably, the content of Mo is within the range of 0.05% or more and 0.40% or less.

### [Content of W]

W is an element that improves hardenability. In order to obtain this effect, the content of W must be 0.05% or more. If the content exceeds 1.00%, weldability may deteriorate. Therefore, when W is added, it is preferable to limit the content of W within the range of 0.05% or more and 1.00% or less. More preferably, the content of W is within the range of 0.05% or more and 0.40% or less.

Mo and W form a solid solution with TiC and therefore have the effect of increasing the mass of the hard phase.

### [Content of B]

B is an element that segregates at grain boundaries and strengthens the grain boundaries to thereby effectively contribute to an improvement in toughness, and the content of B must be 0.0003% or more in order to obtain this effect. If the content exceeds 0.0030%, weldability may deteriorate. Therefore, when B is added, it is preferable to limit the content of B within the range of 0.0003% or more and 0.0030% or less. More preferably, the content of B is within the range of 0.0003% or more and 0.0015% or less.

Moreover, at least one of the elements specified below may be selectively and optionally added, from the viewpoint of, for example, ensuring the strength of the steel pipe material.

### [Content of Nb]

Nb is an element that, when added in combination with Ti, forms a complex carbide of Ti and Nb ((NbTi)C), is dispersed as a hard second phase, and contributes to an improvement in abrasion resistance. In order to obtain the effect of improving abrasion resistance, the content of Nb must be 0.005% or more. If the content exceeds 1.000%, the hard second phase (the complex carbide of Ti and Nb) increases in size, and cracks originating from the hard second phase (the complex carbide of Ti and Nb) occur during bending. Therefore, when Nb is added, it is preferable to limit the content of Nb within the range of 0.005% or more and 1.000% or less. More preferably, the content of Nb is within the range of 0.1% or more and 0.5% or less.

### [Content of V]

As is Nb, V is an element that, when added in combination with Ti, forms a complex carbide of Ti and V ((VTi)C), is dispersed as a hard second phase, and contributes to an improvement in abrasion resistance. In order to obtain the effect of improving abrasion resistance, the content of V must be 0.005% or more. If the content exceeds 1.0%, the hard second phase (the complex carbide of Ti and V) increases in size, and cracks originating from the hard second phase (the complex carbide of Ti and V) occur during bending. Therefore, when V is added, it is preferable to limit the content of V within the range of 0.005% or more and 1.000% or less. More preferably, the content of V is within the range of 0.1% or more and 0.5% or less.

When a combination of Nb and V is added, the hard second phase is (NbVTi)C, and the effect of improving abrasion resistance is also obtained as in the case where a single component is added.

In production of a general steel pipe material, it is inevitable that N is contained in the steel pipe material unless vacuum refining for obtaining high cleanliness steel is specially used. In some cases, N is intentionally contained in the steel pipe material. When N is contained, a carbonitride may be formed in addition to the carbide. The carbonitride provides the same effects as those by the carbide. However, if the content of N exceeds 0.01%, the ratio of N in the carbonitride increases. In this case, the hardness of the hard second phase decreases, and it may be feared that abrasion resistance deteriorates. Therefore, the content of N is preferably within the range of 0.01% or less.

### [Ceq Value]

Ceq is defined as Ceq=C+Mn/6+(Cu+Ni)/15+(Cr+Mo+V)/5. The symbols of elements on the right-hand side of the formula represent the contents of the elements (% by mass), respectively, and the content of an element not contained is set to 0. Ceq is an index representing the hardenability of a weld heat affected zone. The larger the value of Ceq, the larger the increase in the hardness of the weld heat affected zone, and the higher the susceptibility to low-temperature cracking. In the abrasion resistant welded steel pipe according to the present invention, when the Ceq of the steel pipe material exceeds 0.55, the maximum hardness of the seam weld heat affected zone exceeds 350, and the occurrence of low-temperature cracking cannot be avoided unless pre-heating is performed. Therefore, the upper limit of Ceq is set to 0.55.

### [DI* Value]

DI* represented by the following formula (2) must be less than 60.

DI*=33.85×(0.1×C*)^{0.5}×(0.7×Si+1)×(3.33×Mn+1)×(0.35×Cu+1)×(0.36×Ni+1)×(2.16×Cr+1)×(3×Mo*+1)×(1.5×W*+1) (2)

The symbols of elements on the right-hand side of the formula represent the contents of the elements (% by mass), respectively, and the content of an element not contained is set to 0. C*, Mo*, and W* are defined as C*=C−¼×(Ti−48/14N), Mo*=Mo×(1−0.5×(Ti−48/14N), and W*=W×(1−0.5×(Ti−48/14N), and DI*<60.

DI* is an index representing hardenability. The higher the value of DI* is, the higher the hardenability is. C* is a modified index representing the contribution of the C element to the hardenability which is modified in relation to the amounts of other elements, and Mo* and W* are indexes modified on the basis of a similar idea.

When DI* is 60 or more, the structure of the steel pipe base material becomes a mixed structure of ferrite and bainite (which may be referred to simply as “ferrite+bainite”) even when the base material is cooled under the conditions specified in the present invention after hot rolling. In this case, the hardness becomes excessively high, and formability cannot be ensured. Therefore, DI* is specified to be less than 60.

### 1.2 Properties of Steel Pipe Base Material

### [Hardness of Steel Pipe Base Material]

If the hardness, i.e., the Vickers hardness, of the steel pipe base material is less than 150, excellent abrasion resistance is not obtained. Therefore, the lower limit of the hardness of the steel pipe base material is set to 150. If the hardness of the steel pipe base material exceeds 250, workability deteriorates, and it is difficult to produce a pipe by cold working such as UOE or press-bending. Therefore, the upper limit of the hardness of the steel pipe base material is set to 250.

### [Hardness of Weld Heat Affected Zone]

If the hardness, i.e., the Vickers hardness, of the weld heat affected zone of the steel pipe is less than 150, excellent abrasion resistance is not obtained. Therefore, the lower limit of the hardness of the weld heat affected zone of the steel pipe is set to 150. If the maximum hardness of the weld heat affected zone exceeds 350, the susceptibility to low-temperature cracking increases, and the occurrence of delayed fracture cannot be prevented unless post-heating is performed. Therefore, the upper limit of the hardness of the weld heat affected zone of the steel pipe is set to 350.

### [Metallographic Structure]

Preferably, the steel pipe base material according to the present invention has a metallographic structure comprising: a matrix structure including a ferrite structure and a pearlite structure; and a hard phase (hard second phase) dispersed in the matrix structure. The matrix structure means that its volume fraction is 90% or more. In the steel pipe material according to the present invention, the two structures, i.e., the ferrite structure and the pearlite structure, occupy at least 90% of the entire volume. Desirably, the volume fraction of the ferrite structure is 70% or more, and the average circle-equivalent grain diameter of the ferrite structure is 20 μm. The Vickers hardness (Hv) of the matrix structure is preferably 220 or less, in consideration of workability.

### [Dispersion Density of Hard Phase]

The hard phase is preferably a Ti-based carbide such as TiC, and examples thereof may include TiC, (NbTi)C, (VTi)C, and a solid solution of Mo and W in TiC. No particular limitation is imposed on the size of the hard phase. From the viewpoint of abrasion resistance, the size of the hard phase is preferably about 0.5 μm or more and 50 μm or less. From the viewpoint of abrasion resistance, the dispersion density of the hard phase is preferably 400 grains/mm² or more. The size of the hard phase is determined as follows. The area of each of the grains of the hard phase is measured, and a circle-equivalent diameter is computed from the measured area. Then the arithmetic mean of the obtained circle-equivalent diameters is computed and used as the size (the average grain diameter) of the hard phase in the steel plate.

### 2. Weld Metal

### 2.1 Chemical Composition of Weld Metal

The reasons for limitations on the chemical composition of a weld metal for a welded steel pipe produced by cold-working a thick steel plate into a tubular shape and then welding its butt portion (this weld metal may be referred to simply as a “weld metal”) will next be described.

### [Content of C]

C can increase the hardness of the weld metal and improve its abrasion resistance, and the content of C must be 0.05% or more in order to obtain this effect. If the content is 0.30% or more, the hardness of the weld metal becomes high, and the susceptibility to low-temperature cracking increases. Therefore, the content of C is specified to be within the range of 0.05% or more and less than 0.30%. Preferable, the content of C is within the range of 0.15% or more and 0.25% or less.

### [Content of Si]

Si is an element effective as a deoxidizing element and also has the effect of increasing the strength of the weld metal. To obtain this effect, the content of Si must be 0.05% or more. If the content is 0.50% or more, problems such as a reduction in ductility and toughness and an increase in the amount of inclusions occur. Therefore, the content of Si is limited within the range of 0.05% or more and less than 0.50%. Preferably, the content of Si is within the range of 0.05% or more and 0.40% or less.

### [Content of Mn]

Mn is an element that increases hardenability and can reduce the size of the structure of the weld metal and improve its strength and toughness. To obtain this effect, the content of Mn must be 0.1% or more. If the content exceeds 2.0%, hardenability is excessively increased, so that weldability and toughness deteriorate. Therefore, the content of Mn is limited within the range of 0.1% or more and 2.0% or less. Preferably, the content of Mn is within the range of 0.1% or more and 1.60% or less.

### [Content of P]

P is an impurity element, and the content of P is preferably as low as possible from the viewpoint of the toughness of the weld metal and its susceptibility to high-temperature cracking resistance. However, to reduce the content of P, the contents of P in a welding wire and the steel pipe base material must be reduced, and this causes an increase in the cost in their steel-making process. Therefore, the allowable content of P is within the range of 0.03% or less. More preferably, the content of P is within the range of 0.015% or less.

### [Content of S]

S is an impurity element, and the content of S is preferably as low as possible from the viewpoint of the ductility of the weld metal and its susceptibility to high-temperature cracking resistance. However, to reduce the content of S, the contents of S in the welding wire and the steel pipe base material must be reduced, and this causes an increase in the cost in their steel-making process. Therefore, the allowable content of S is within the range of 0.01% or less.

### [Content of Al]

Al is contained to deoxidize the weld metal. However, if the content of Al exceeds 0.1%, the toughness of the weld metal deteriorates. Therefore, the content of Al should be within the range of 0.1% or less. Preferably, the content of Al is within the range of 0.03% or less.

### [Content of Ti]

Ti facilitates the formation of spherical TiS in a final solidification zone of the weld metal and suppresses the formation of film-shaped FeS. This effect is obtained when the content of Ti is 0.05% or more. Therefore, the lower limit of the content of Ti is set to 0.05%. When the content of Ti exceeds 1.2%, coarse TiC is precipitated, and the toughness of the weld metal deteriorates significantly. Therefore, the upper limit of the content of Ti is set to 1.2%. Preferably, the content of Ti is within the range of 0.05% or more and 0.5% or less.

### [Content of N]

N is an element unavoidably contained in the weld metal. When N is present in a solid solution state, the toughness of the weld metal deteriorates significantly. Even when Ti is contained to fix N as TiN, the deterioration of the toughness cannot be suppressed when the content of N exceeds 0.008%. Therefore, the upper limit of the content of N is set to 0.008%.

### [Content of O]

O has a large influence on the toughness of the weld metal. If the content of O exceeds 0.08%, the toughness of the weld metal deteriorates. Therefore, the upper limit of the content of O is set to 0.08%. If the content is less than 0.02%, the weld metal has a structure quenched to an excessive degree, and this results in an increase in hardness. In addition, the formation of FeO in the final solidification zone is inhibited, and generation of film-shaped FeS is facilitated, so that susceptibility to high-temperature cracking increases. Therefore, the lower limit of the content of O is set to 0.02%. More preferably, the content of O is within the range of 0.04% or more and 0.08% or less.

From the viewpoint of, for example, ensuring the strength of the weld metal in the welded steel pipe and of dilution from the steel pipe base material, at least one of the elements specified below may be selectively contained.

### [Content of Cu]

Cu is an element that forms a solid solution and thereby improves hardenability, and the content of Cu must be 0.1% or more in order to obtain this effect. If the content exceeds 1.0%, the toughness of the weld metal deteriorates. Therefore, it is preferable to limit the content of Cu within the range of 0.1% or more and 1.0% or less. More preferably, the content of Cu is within the range of 0.1% or more and 0.5% or less.

### [Content of Ni]

Ni is an element that forms a solid solution and thereby improves hardenability, and this effect is significant when the content of Ni is 0.1% or more. If the content exceeds 2.0%, the material cost increases significantly. Therefore, when Ni is contained, it is preferable to limit the content of Ni within the range of 0.1% or more and 2.0% or less. More preferably, the content of Ni is within the range of 0.1% or more and 1.0% or less.

### [Content of Cr]

Cr has the effect of improving hardenability, and the content of Cr must be 0.1% or more in order to obtain this effect. However, if the content exceeds 0.1%, weldability deteriorates. Therefore, when Cr is contained, it is preferable to limit the content of Cr within the range of 0.1% or more and 1.0% or less. More preferably, the content of Cr is within the range of 0.1% or more and 0.8% or less. Still more preferably, the content of Cr is within the range of 0.4% or more and 0.7% or less.

### [Content of Mo]

Mo is an element that improves hardenability. In order to obtain this effect, the content of Mo must be 0.05% or more. If the content exceeds 1.0%, weldability deteriorates. Therefore, when Mo is contained, it is preferable to limit the content of Mo within the range of 0.05% or more and 1.00% or less. More preferably, the content of Mo is within the range of 0.05% or more and 0.40% or less.

### [Content of W]

W is an element that improves hardenability. In order to obtain this effect, the content of W must be 0.05% or more. If the content exceeds 1.00%, weldability deteriorates. Therefore, when W is contained, it is preferable to limit the content of W within the range of 0.05% or more and 1.0% or less. More preferably, the content of W is within the range of 0.05% or more and 0.40% or less.

### [Content of B]

B is an element that segregates at grain boundaries and strengthens the grain boundaries to thereby effectively contribute to an improvement in toughness, and the content of B must be 0.0003% or more in order to obtain this effect. If the content exceeds 0.0030%, weldability deteriorates. In addition, Fe₃(CB)₆ etc. may precipitate during cooling after welding, so that toughness deteriorates significantly. Therefore, when B is contained, it is preferable to limit the content of B within the range of 0.0003% or more and 0.0030% or less. More preferably, the content of B is within the range of 0.0003% or more and 0.0015% or less.

From the viewpoint of, for example, ensuring the strength of the weld metal and of dilution from the steel pipe base material, at least one of the elements specified below may be selectively and optionally contained. More specifically, at least one of Nb: 0.005% or more and 1.000% or less and V: 0.005% or more and 1.000% or less may be selected for each of the weld metal and the base material, independently or selected such that the chemical composition of the weld metal becomes the same as that of the base material. The selection made such that the chemical composition of the weld metal becomes the same as that of the base material can provide an effect in that the base material and the weld metal have similar properties.

### [Content of Nb]

Nb is an element that improves the strength of the weld metal by precipitation strengthening. This effect is obtained when the content of Nb is 0.005% or more, and toughness deteriorates when the content exceeds 1.000%. Therefore, when Nb is contained, the content of Nb is set within the range of 0.005% or more and 1.000% or less.

### [Content of V]

V is an element that improves the strength of the weld metal by precipitation strengthening and solid solution strengthening. This effect is obtained when the content of V is 0.005% or more, and toughness deteriorates when the content exceeds 1.000%. Therefore, when V is contained, the content of V is set within the range of 0.005% or more and 1.000% or less.

### [Ceq Value]

In the weld metal of the welded steel pipe, when the Ceq defined by the formula (1) described above exceeds 0.55, the maximum hardness of the weld heat affected zone exceeds 350, and the occurrence of low-temperature cracking cannot be avoided unless pre-heating is performed before welding. Therefore, the upper limit of Ceq is set to 0.55.

### [UCS Value]

UCS is defined by the formula (3) below and is an index representing susceptibility to high-temperature cracking. The larger the value of UCS is, the more high-temperature cracking is likely to occur.

UCS=230×C−12.3×Si−5.4×Mn+75×P+190×S−14×Al+45×Nb−1 (3)

The symbols of elements on the right-hand side of the formula represent the contents of the elements (% by mass), respectively, and the content of an element not contained is set to 0.

In the weld metal in the welded steel pipe, if UCS is 42 or higher, the occurrence of high-temperature cracking cannot be avoided. Therefore, UCS is less than 42. More preferably, UCS is less than 40.

### [PTI Value]

PTI is defined by the formula (4) below and is a parameter specifying the state of precipitation of Ti in the weld metal. If PTI is less than 0, S does not form TiS, but film-shaped FeS is formed. In this case, susceptibility to high-temperature cracking becomes high. Therefore, PTI is set to 0 or more.

PTI=Ti−1.5×(O−0.89×Al)−3.4×N−4.5×S (4)

The symbols of elements on the right-hand side of the formula represent the contents of the elements (% by mass), respectively, and the content of an element not contained is set to 0.

### 2.2 Properties of Weld Metal

### [Hardness of Weld Metal]

In the weld metal, TiC crystallized in the base material forms a solid solution. Therefore, to ensure the same abrasion resistance as that in the base material and the weld heat affected zone, higher hardness must be secured, and the Vickers hardness must be 230 or higher to obtain sufficient abrasion resistance. However, if the maximum Vickers hardness exceeds 350, susceptibility to low-temperature cracking becomes high, and the occurrence of delayed fracture cannot be prevented unless post-heating is performed. Therefore, the upper limit of Vickers hardness is set to 350.

### [Dispersion Density of Sulfide]

In the weld metal, S segregates in a final solidification zone during a solidification process. In the final solidification zone, S forms a film-shaped sulfide composed mainly of FeS and having low ductility, and the sulfide serves as starting points of high-temperature cracking. Sulfide-forming elements such as Mn and Ti are also combined in the film-shaped sulfide formed mainly of FeS. Therefore, the sulfide is limited to that containing at least one selected from Fe, Mn, and Ti.

From the viewpoint of suppressing high-temperature cracking, it is preferable that the amount of the film-shaped sulfide be as low as possible. However, when, for example, stirring during solidification of the weld metal is insufficient, film-shaped sulfide having an aspect ratio of 5 or more may remain present. Even when the sulfide containing at least one selected from Fe, Mn, and Ti is present, if the aspect ratio of the sulfide is less than 5, the sulfide does not serve as the starting points of high-temperature cracking, so that the dispersion density of the sulfide is not an issue. However, when the sulfide containing at least one selected from Fe, Mn, and Ti has an aspect ratio of 5 or more, the sulfide may serve as the starting points of high-temperature cracking.

When the dispersion density of the sulfide containing at least one selected from Fe, Mn, and Ti and having an aspect ratio of 5 or more is 10 grains/mm² or less, no high-temperature cracking occurs. Therefore, the upper limit of the dispersion density of the sulfide is set to 10 grains/mm². This range of the dispersion density can be achieved by controlling the contents of mainly Mn, Ti, and S, and USC and PTI within the above-described ranges for the chemical composition of the weld metal.

The dispersion density of the sulfide having an aspect ratio of 5 or more is measured as in Examples described later. The aspect ratio of a sulfide is determined as follows. The shape of the sulfide is observed, and the lengths in its long and short directions are measured. The aspect ratio means the ratio of the measured lengths (=the length in the long direction/the length in the short direction).

### 3. Production Method

### 3.1 Method of Producing Steel Pipe Material

The abrasion resistant steel plate according to the present invention may be produced by preparing molten steel having the above-described composition by melting using a known smelting method and then forming a steel material such as a slab having prescribed dimensions using a continuous casting method or an ingot making-blooming rolling method. Even when the ingot-making method is used, the size of the ingot and the cooling conditions must be controlled to desirably adjust the size and number of grains of the hard phase. For example, with the continuous casting method, it is preferable, in order to adjust the size and number of grains of the hard phase to prescribed values, that cooling be adjusted and controlled such that the cooling rate of a casted piece of a thickness of 200 mm to 400 mm in a temperature range of 1,500° C. to 1,200° C. is within the range of 0.2° C./s to 10° C./s.

Preferably, the slab is immediately hot-rolled without forced cooling such as water cooling or is cooled, then re-heated to 950 to 1,250° C., and hot-rolled to obtain a thick steel plate having a desired thickness. In the present invention, the thick steel plate is a steel plate having a thickness within the range of 6 mm to 50 mm. After hot rolling, cooling is performed at a cooling rate of 2° C./s or less without any heat treatment. If the cooling rate exceeds 2° C./s, the ferrite-pearlite structure is less likely to be obtained. In this case, the tensile strength may become 800 MPa or more, and the working load during bending of the steel plate may become high, so that workability deteriorates. Therefore, the cooling rate is set to be 2° C./s or less. The cooling rate is the average cooling rate and is measured by, for example, a method of measuring surface temperature using a radiation thermometer etc.

No particular limitation is imposed on the hot rolling conditions, so long as a steel plate having a desired shape and desired dimensions can be obtained. When particular consideration is given to toughness as the required performance of the thick steel plate, the rolling reduction ratio at a surface temperature of 920° C. or lower is set to preferably 30% or more, and the rolling finishing temperature is set to preferably 900° C. or lower. It is not necessary for the steel pipe material according to the present invention to be subjected to heat treatment after hot rolling, and the hot-rolled steel pipe material as is can be used for various applications that require bending.

Preferably, submerged arc welding is used as a method of welding the butt portion of a thick steel plate cold-worked into a tubular shape, from the viewpoint of control of the chemical composition of the weld metal and efficiency of welding operation. Multielectrode submerged arc welding may be used from the viewpoint of speeding up. The welding material is not particularly specified. However, to satisfy the specified ranges of the chemical composition of the weld metal in the present invention, the flux used is preferably an acidic flux of the molten type. Preferably, no B is added to the flux and wire, and the amounts of P and S are reduced as much as possible.

### EXAMPLES

Molten steel having one of various compositions shown in TABLE 1 was formed into a slab by continuous casting. The slab was heated to 1,130° C. in a continuous furnace and subjected to hot rolling such that the final rolling temperature was 850° C.±20° C. to thereby form a thick steel plate having a thickness of 15 mm. Then the thick steel plate was cooled under various conditions (air cooling, water shower).

TABLE 1
CHEMICAL COMPOSITION OF BASE MATERIAL OF WELDED STEEL PIPE (% BY MASS)

| STEEL | | | | | | | | | | | | | | | | | | |
|---|---|---|---|---|---|---|---|---|---|---|---|---|---|---|---|---|---|---|
| TYPE | | | | | | | | | | | | | | | | | | |
| NO. | C | Si | Mn | P | S | Al | Cu | Ni | Cr | Mo | W | Nb | V | Ti | B | N | Ceq | DI* |
| A | 0.12 | 0.33 | 1.22 | 0.015 | 0.003 | 0.025 | — | — | 0.81 | 0.12 | — | — | — | 0.28 | 0.0011 | 0.0025 | 0.509 | 54.92 |
| B | 0.25 | 0.27 | 1.12 | 0.012 | 0.008 | 0.051 | 0.45 | 0.35 | — | 0.24 | 0.33 | — | — | 0.67 | — | 0.0029 | 0.538 | 45.15 |
| C | 0.25 | 0.29 | 0.88 | 0.011 | 0.004 | 0.051 | — | — | 0.28 | 0.12 | — | — | 0.05 | 0.77 | — | 0.0029 | 0.487 | 24.33 |
| D | 0.25 | 0.23 | 0.83 | 0.015 | 0.003 | 0.051 | — | — | 0.33 | 0.15 | — | 0.31 | — | 0.63 | 0.0025 | 0.0029 | 0.484 | 32.36 |
| E | 0.28 | 0.33 | 0.78 | 0.012 | 0.004 | 0.038 | — | — | 0.34 | 0.11 | — | — | — | 0.01 | 0.0022 | 0.0033 | 0.500 | 57.90 |
| F | 0.24 | 0.29 | 1.18 | 0.013 | 0.005 | 0.044 | — | — | 0.57 | 0.22 | — | — | — | 0.9 | 0.0017 | 0.0034 | 0.595 | 25.91 |
| G | 0.22 | 0.35 | 1.44 | 0.013 | 0.003 | 0.048 | — | — | 0.46 | 0.18 | — | — | — | 0.01 | — | 0.0043 | 0.588 | 111.61 |
| H | 0.31 | 0.36 | 0.71 | 0.013 | 0.003 | 0.045 | — | — | 1.02 | 0.23 | — | — | 0.045 | 0.38 | 0.0008 | 0.0033 | 0.687 | 105.34 |

Underlined field represents comparative example

The widthwise opposite edges of the obtained thick steel plate were subjected to edge preparation, and the thick steel plate was formed into a tubular shape by UO forming such that the width direction of the thick steel plate became a circumferential direction. The open ends were butted against each other and tack-welded by GMAW from the outer side. Then a combination of welding materials (a welding wire and a flux) shown in TABLEs 2 and 3 was used to perform two-electrode submerged arc welding on two surfaces, i.e., the inner and outer surfaces, (inner surface: 3.0 kJ/mm, outer surface: 3.4 kJ/mm). The resultant pipe was subjected to pipe expansion to thereby produce a welded steel pipe. TABLE 4 shows the welding conditions and combinations of the welding materials used for the two-electrode submerged arc welding on the two surfaces, i.e., the inner and outer surfaces. TABLE 5 shows the chemical composition of weld metals in welded steel pipes.

TABLE 2
CHEMICAL COMPOSITION OF WELDING WIRE (% BY MASS)

| WIRE | | | | | | | | | | |
|---|---|---|---|---|---|---|---|---|---|---|
| SYMBOL | C | Si | Mn | P | S | Al | Cu | Cr | Mo | Ti |
| a | 0.05 | 0.12 | 1.96 | 0.005 | 0.006 | 0.03 | 0.11 | 0.02 | — | 0.24 |
| b | 0.05 | 0.01 | 2.00 | 0.01 | 0.005 | 0.03 | 0.15 | — | — | — |
| C | 0.19 | 0.5 | 1.51 | 0.005 | 0.003 | 0.03 | 0.12 | — | 0.52 | 0.09 |

TABLE 3
CHEMICAL COMPOSITION OF FLUX (% BY MASS)

| FLUX | | | | | | | | | |
|---|---|---|---|---|---|---|---|---|---|
| SYMBOL | SiO₂ | MnO | Al₂O₃ | CaO | CaF₂ | MgO | TiO₂ | B₂O₃ | FeO |
| d | 43.8 | 39 | 3.4 | 5.8 | 5.9 | 0.6 | — | — | 0.2 |
| e | 32 | 8.3 | 11.1 | 17.5 | 16.3 | 9 | 2.6 | 0.4 | — |

TABLE 4
WELDING CONDITIONS FOR WELDED STEEL PIPE

| | | COOLING | COMBINATION OF | |
|---|---|---|---|---|
| WELDED | | RATE AFTER | WELDING MATERIALS | |
| STEEL PIPE | STEEL | ROLLING | COMBINATION | FLUX |
| NO. | TYPE NO. | (° C./s) | OF WIRES | SYMBOL |
| 1 | A | 0.5 | a-a | d |
| 2 | B | 0.5 | a-a | d |
| 3 | C | 0.5 | a-a | d |
| 4 | D | 0.5 | a-a | d |
| 5 | E | 0.5 | a-a | d |
| 6 | F | 0.5 | a-a | d |
| 7 | G | 0.5 | a-a | d |
| 8 | H | 0.5 | a-a | d |
| 9 | A | 0.5 | b-b | d |
| 10 | D | 0.5 | c-c | d |
| 11 | A | 0.5 | a-a | e |
| 12 | A | 10 | — | — |
| 13 | A | 50 | — | — |

Underlined field represents comparative example.

TABLE 5
CHEMICAL COMPOSITION OF WELD METAL PORTION
IN WELDED STEEL PIPE (% BY MASS)

| STEEL | | | | | | | | | | | |
|---|---|---|---|---|---|---|---|---|---|---|---|
| TYPE | | | | | | | | | | | |
| NO. | C | Si | Mn | P | S | Al | Cu | Ni | Cr | Mo | W |
| 1 | 0.09 | 0.25 | 1.52 | 0.011 | 0.004 | 0.007 | 0.04 | — | 0.49 | 0.07 | — |
| 2 | 0.17 | 0.21 | 1.46 | 0.009 | 0.007 | 0.011 | 0.31 | 0.21 | 0.01 | 0.14 | 0.20 |
| 3 | 0.17 | 0.22 | 1.31 | 0.009 | 0.005 | 0.011 | 0.04 | — | 0.18 | 0.07 | — |
| 4 | 0.17 | 0.19 | 1.28 | 0.011 | 0.004 | 0.011 | 0.04 | — | 0.21 | 0.09 | — |
| 5 | 0.19 | 0.25 | 1.25 | 0.009 | 0.005 | 0.009 | 0.04 | — | 0.21 | 0.07 | — |
| 6 | 0.16 | 0.22 | 1.49 | 0.010 | 0.005 | 0.010 | 0.04 | — | 0.35 | 0.13 | — |
| 7 | 0.15 | 0.26 | 1.65 | 0.010 | 0.004 | 0.010 | 0.04 | — | 0.28 | 0.11 | — |
| 8 | 0.21 | 0.26 | 1.21 | 0.010 | 0.004 | 0.010 | 0.04 | — | 0.62 | 0.14 | — |
| 9 | 0.09 | 0.20 | 1.53 | 0.013 | 0.004 | 0.007 | 0.06 | — | 0.49 | 0.07 | — |
| 10 | 0.23 | 0.34 | 1.10 | 0.011 | 0.003 | 0.011 | 0.05 | — | 0.20 | 0.30 | — |
| 11 | 0.09 | 0.24 | 1.56 | 0.010 | 0.004 | 0.008 | 0.03 | — | 0.51 | 0.08 | — |

| STEEL | | | | | | | | | |
|---|---|---|---|---|---|---|---|---|---|
| TYPE | | | | | | | | | |
| NO. | Nb | V | Ti | B | N | O | Ceq | UCS | PTI |
| 1 | — | — | 0.14 | 0.0007 | 0.0058 | 0.0556 | 0.461 | 10.48 | 0.03 |
| 2 | — | — | 0.27 | — | 0.0056 | 0.0552 | 0.478 | 29.56 | 0.15 |
| 3 | — | 0.030 | 0.30 | — | 0.0060 | 0.0536 | 0.447 | 29.69 | 0.19 |
| 4 | 0.186 | — | 0.26 | 0.0015 | 0.0056 | 0.0600 | 0.446 | 38.73 | 0.14 |
| 5 | — | — | 0.06 | 0.0013 | 0.0058 | 0.0560 | 0.455 | 33.93 | −0.06 |
| 6 | — | — | 0.34 | 0.0010 | 0.0060 | 0.0620 | 0.512 | 27.56 | 0.22 |
| 7 | — | — | 0.06 | — | 0.0058 | 0.0556 | 0.508 | 23.28 | −0.05 |
| 8 | — | 0.027 | 0.17 | 0.0005 | 0.0061 | 0.0569 | 0.568 | 38.00 | 0.06 |
| 9 | — | — | 0.09 | 0.0007 | 0.0058 | 0.0556 | 0.463 | 11.01 | −0.02 |
| 10 | 0.186 | — | 0.22 | 0.0015 | 0.0050 | 0.0601 | 0.512 | 50.49 | 0.12 |
| 11 | — | — | 0.15 | 0.0061 | 0.0060 | 0.0560 | 0.472 | 10.18 | 0.04 |

Underlined field represents comparative example.

Each of the obtained welded steel pipes was subjected to weld defect examination, microstructure observation, a hardness test, and an abrasion test. In the weld defect examination, defect examination by a liquid penetrant test and an X-ray test was performed over the entire length (12 m) of the welded steel pipe, in order to detect weld defects mainly due to high-temperature cracking. When the liquid penetrant test gave an indication and the X-ray test gave two or more indications, the welded steel pipe was considered to fail.

In the metallographic structure observation, a test piece for microstructure observation was taken from the base material of each of the obtained welded steel pipes. The test piece was polished and etched with nital. Then the microstructure at a position 1 mm below the surface of the test piece was observed under an optical microscope, and the size and number of grains of the hard phase were measured. The density of the hard phase was determined as follows. Observation under a scanning electron microscope (hereinafter abbreviated as an “SEM,” magnification: 5,000×) was performed, and the hard phase was identified by energy-dispersive X-ray fluorescence analysis (hereinafter abbreviated as “EDX analysis”). The number of grains was measured by the method described above, and the average value was used as the dispersion density. A precipitate in the weld metal was observed under the SEM (5,000×). The film-shaped precipitate found under the SEM was subjected to EDX analysis and was identified as a target sulfide, and the number of grains with an aspect ratio of 5 or more in the observation plane was measured.

The hardness of the welded joint taken from the inner surface of the welded steel pipe was measured at a position 1 mm below the inner surface using a 10 kgf Vickers hardness meter. More specifically, the measurement was performed on the base material, the weld heat affected zone (HAZ), and the weld metal (WM). The abrasion test was performed as follows. Flattened test pieces (pipe thickness×20×75 mm) were taken from the base material and welded portion of each of the obtained welded steel pipes. Then a rubber wheel abrasion test was performed using abrasive sand according to the specifications in ASTM G65. A test piece was taken from the welded portion such that the seam direction became the lengthwise direction. A ground surface of a build-up portion of an outer surface was used as a test surface, and the amount of abrasion of the test piece was measured and evaluated.

The amount of abrasion of the test piece was evaluated using, as a reference amount (1.0), the amount of abrasion of a plate of a general structural rolled steel material (SS400), i.e., as the ratio of abrasion resistance=the amount of abrasion of the soft steel plate/the amount of abrasion of each steel plate. The larger the ratio of abrasion resistance is, the better the abrasion resistance is. In this case, a steel plate having an abrasion resistance ratio of 4.0 or more is considered to a steel plate having excellent abrasion resistance. When a welded steel pipe could not be produced because the power of the press was insufficient or the expended pipe was cracked during pipe-making, the situation was noted in remarks, and the test piece was considered to fail.

The results obtained are shown in TABLE 6. In Inventive Examples, the ratio of abrasion resistance was 4 or more, and not only excellent abrasion resistance was achieved, but also the interior quality of the welded portion was favorable. In Comparative Examples, at least one of these properties was worse than that in the Inventive Examples.

TABLE 6
PROPERTIES OF WELDED STEEL PIPE AND RESULTS OF ABRASION TEST

| WELDED | | METALLOGRAPHIC | DISPERSION | DISPERSION | | |
|---|---|---|---|---|---|---|
| STEEL | STEEL | STRUCTURE OF | DENSITY OF | DENSITY OF | | HARDNESS (Hv) |
| PIPE | TYPE | STEEL PIPE | HARD PHASE | SULFIDE*¹ | WELD | BASE |
| NO. | NO. | BASE MATERIAL | (GRAINS/mm²) | (GRAINS/mm²) | DEFECT*² | MATERIAL |
| 1 | A | FERRITE + | 620 | 5 | ∘ | 206 |
| | | PEARLITE | | | | |
| 2 | B | FERRITE + | 850 | 0 | ∘ | 202 |
| | | PEARLITE | | | | |
| 3 | C | FERRITE + | 800 | 0 | ∘ | 192 |
| | | PEARLITE | | | | |
| 4 | D | FERRITE + | 750 | 0 | ∘ | 190 |
| | | PEARLITE | | | | |
| 5 | E | FERRITE + | 0 | 50 | x | 200 |
| | | PEARLITE | | | | |
| 6 | F | FERRITE + | 960 | 0 | Δ | 220 |
| | | PEARLITE | | | | |
| 7 | G | FERRITE + | 0 | 45 | ∘ | 255 |
| | | PEARLITE | | | | |
| 8 | H | FERRITE + | 670 | 2 | ∘ | 265 |
| | | PEARLITE | | | | |
| 9 | A | FERRITE + | 610 | 28 | ∘ | 207 |
| | | PEARLITE | | | | |
| 10 | D | FERRITE + | 740 | 0 | x | 195 |
| | | PEARLITE | | | | |
| 11 | A | FERRITE + | 610 | 2 | x | 209 |
| | | PEARLITE | | | | |

| | | | |
|---|---|---|---|
| 12 | A | FERRITE + | CRACKING DURING PIPE EXPANSION (HARDNESS OF BASE MATERIAL: 300) |
| | | PEARLITE | |
| 13 | A | MARTENSITE | UO PRESSING IMPOSSIBLE (HARDNESS OF BASE MATERIAL: 390) |

| | HARDNESS (Hv) | | RATIO OF ABRASION | | |
|---|---|---|---|---|---|
| STEEL | WELD HEAT | | RESISTANCE | | |
| TYPE | AFFECTED | WELD | BASE | WELDED | |
| NO. | ZONE | METAL | MATERIAL | PORTION | REMARKS |
| 1 | 325 | 265 | 4.6 | 4.8 | Inventive |
| | | | | | Example |
| 2 | 340 | 270 | 5.2 | 5.6 | Inventive |
| | | | | | Example |
| 3 | 320 | 250 | 5.6 | 4.3 | Inventive |
| | | | | | Example |
| 4 | 315 | 251 | 5.2 | 4.2 | Inventive |
| | | | | | Example |
| 5 | 320 | 255 | 1.6 | 1.8 | Comparative |
| | | | | | Example |
| 6 | 380 | 325 | 4.8 | 5.9 | Comparative |
| | | | | | Example |
| 7 | 385 | 310 | 2.4 | 2.5 | Comparative |
| | | | | | Example |
| 8 | 405 | 362 | 5.9 | 6.5 | Comparative |
| | | | | | Example |
| 9 | 332 | 270 | 4.6 | 5.0 | Comparative |
| | | | | | Example |
| 10 | 290 | 320 | 5.1 | 5.4 | Comparative |
| | | | | | Example |
| 11 | 328 | 360 | 4.7 | 5.1 | Comparative |
| | | | | | Example |

| | | |
|---|---|---|
| 12 | CRACKING DURING PIPE EXPANSION (HARDNESS OF BASE MATERIAL: 300) | Comparative |
| | | Example |
| 13 | UO PRESSING IMPOSSIBLE (HARDNESS OF BASE MATERIAL: 390) | Comparative |
| | | Example |

Underlined field represents comparative example.
NOTE
^{*1}Sulfide with aspect ratio of 5 or more
^{*2}Weld Defect: Cross represents defects due to high-temperature cracking, and triangle represents defects due to low-temperature cracking.

The embodiments to which the invention made by the present inventors is applied have been described. However, the present invention is not limited to the description in the embodiments that forms part of the disclosure of the present invention. Specifically, other embodiments, examples, operational techniques, etc. performed by, for example, those skilled in the art according to any of the above embodiments are all encompassed by the scope of the present invention.

### INDUSTRIAL APPLICABILITY

The present invention is applicable to piping used to transport a transportation object such as gravel or coal combustion ash.

1. An abrasion resistant welded steel pipe having excellent weld crack resistance and produced by cold-working a thick steel plate into a tubular shape and subjecting the resultant thick steel plate to butt welding, wherein
a base material of the abrasion resistant welded steel pipe is formed of chemical composition including, in terms of percent by mass, C: 0.05% or more and less than 0.40%, Si: 0.05% or more and less than 0.5%, Mn: 0.1% or more and 2.0% or less, P: 0.03% or less, S: 0.01% or less, Al: 0.1% or less, and Ti: 0.1% or more and 1.2% or less and further including at least one selected from Cu: 0.1% or more and 1.0% or less, Ni: 0.1% or more and 2.0% or less, Cr: 0.1% or more and 1.0% or less, Mo: 0.05% or more and 1.00% or less, W: 0.05% or more and 1.00% or less, and B: 0.0003% or more and 0.0030% or less, with the balance being Fe and unavoidable impurities, Ceq represented by the following formula (1) being 0.55 or less, DI* represented by the following formula (2) being less than 60,
a weld metal of the abrasion resistant welded steel pipe is formed of chemical composition including,
in terms of percent by mass, C: 0.05% or more and less than 0.30%, Si: 0.05% or more and less than 0.50%, Mn: 0.1% or more and 2.0% or less, P: 0.03% or less, S: 0.01% or less, Al: 0.1% or less, Ti: 0.05% or more and 1.2% or less, N: 0.008% or less, and O: 0.02% or more and 0.08% or less and further including at least one selected from Cu: 0.1% or more and 1.0% or less, Ni: 0.1% or more and 2.0% or less, Cr: 0.1% or more and 1.0% or less, Mo: 0.05% or more and 1.00% or less, W: 0.05% or more and 1.00% or less, and B: 0.0003% or more and 0.0030% or less, with the balance being Fe and unavoidable impurities, Ceq represented by the following formula (1) being 0.55 or less, UCS represented by the following formula (3) being less than 42, PTI represented by the following formula (4) being 0 or more,
the base material of the abrasion resistant welded steel pipe has a Vickers hardness within a range of 150 to 250, the weld metal has a Vickers hardness within a range of 230 to 350, and a weld heat affected zone in the abrasion resistant welded steel pipe has a Vickers hardness within a range of 150 to 350, and
in the weld metal, the dispersion density of a sulfide having an aspect ratio of 5 or more and containing at least one selected from Fe, Mn, and Ti is 10 grains/mm² or less:
Ceq=C+Mn/6+(Cu+Ni)/15+(Cr+Mo+V)/5, (1)
DI*=33.85×(0.1×C*)^{0.5}×(0.7×Si+1)×(3.33×Mn+1)×(0.35×Cu+1)×(0.36×Ni+1)×(2.16×Cr+1)×(3×Mo*+1)×(1.5×W*+1), (2)
where C*=C−¼×(Ti−48/14×N), Mo*=Mo×[1−0.5×(Ti−48/14×N)], and W*=W×[1−0.5×(Ti−48/14×N)],
UCS=230×C−12.3×Si−5.4×Mn+75×P+190×S−14×Al+45×Nb−1, and (3)
PTI=Ti−1.5×(O−0.89×Al)−3.4×N−4.5×S, (4)
wherein symbols of elements on the right-hand side of each formula represent contents of the elements (% by mass), respectively, and a content of an element not contained is set to 0.

2. The abrasion resistant welded steel pipe according to claim 1, wherein the chemical composition of at least one of the base material and the weld metal of the abrasion resistant welded steel pipe include, in terms of percent by mass, at least one selected from Nb: 0.005% or more and 1.000% or less and V: 0.005% or more and 1.000% or less.

3. The abrasion resistant welded steel pipe according to claim 1, wherein the base material of the abrasion resistant welded steel pipe has a metallographic structure including: a matrix structure including a ferrite structure and a pearlite structure; and a hard phase dispersed in the matrix structure.

4. The abrasion resistant welded steel pipe according to claim 3, wherein a dispersion density of the hard phase is 400 grains/mm² or more.

5. A method of producing the abrasion resistant welded steel pipe having excellent weld crack resistance and produced by cold-working a thick steel plate into a tubular shape and subjecting the resultant thick steel plate to butt welding, wherein
a base material of the abrasion resistant welded steel pipe is formed of chemical composition including, in terms of percent by mass, C: 0.05% or more and less than 0.40%, Si: 0.05% or more and less than 0.5%, Mn: 0.1% or more and 2.0% or less, P: 0.03% or less, S: 0.01% or less, Al: 0.1% or less, and Ti: 0.1% or more and 1.2% or less and further including at least one selected from Cu: 0.1% or more and 1.0% or less, Ni: 0.1% or more and 2.0% or less, Cr: 0.1% or more and 1.0% or less, Mo: 0.05% or more and 1.00% or less, W: 0.05% or more and 1.00% or less, and B: 0.0003% or more and 0.0030% or less with the balance being Fe and unavoidable impurities, Ceq represented by the following formula (1) being 0.55 or less, DI* represented by the following formula (2) being less than 60,
a weld metal of the abrasion resistant welded steel pipe is formed of chemical composition including,
in terms of percent by mass, C: 0.05% or more and less than 0.30%, Si: 0.05% or more and less than 0.50%, Mn: 0.1% or more and 2.0% or less P: 0.03% or less, S: 0.01% or less, Al: 0.1% or less, Ti: 0.05% or more and 1.2% or less, N: 0.008% or less, and O: 0.02% or more and 0.08% or less and further including at least one selected from Cu: 0.1% or more and 1.0% or less Ni: 0.1% or more and 2.0% or less, Cr: 0.1% or more and 1.0% or less Mo: 0.05% or more and 1.00% or less, W: 0.05% or more and 1.00% or less, and B: 0.0003% or more and 0.0030% or less, with the balance being Fe and unavoidable impurities, Ceq represented by the following formula 1 being 0.55 or less, UCS represented by the following formula (3) being less than 42, PTI represented by the following formula (4) being 0 or more,
the base material of the abrasion resistant welded steel pipe has a Vickers hardness within a range of 150 to 250, the weld metal has a Vickers hardness within a range of 230 to 350, and a weld heat affected zone in the abrasion resistant welded steel pipe has a Vickers hardness within a range of 150 to 350, and
in the weld metal, the dispersion density of a sulfide having an aspect ratio of 5 or more and containing at least one selected from Fe, Mn, and Ti is 10 grains/mm² or less:
Ceq=C+Mn/6+(Cu+Ni)/15+(Cr+Mo+V)/5, (1)
DI*=33.85×(0.1×C*)0.5×(0.7×Si+1)×(3.33×Mn+1)×(0.35×Cu+1)×(0.36×Ni+1)×(2.16×Cr+1)×(3×Mo*+1)×(1.5×W*+1), (2)
where C*=C−¼×(Ti−48/14×N), Mo*=Mo×[1−0.5×(Ti−48/14×N)], and W*=W×[1−0.5×(Ti−48/14×N)],
UCS=230×C−12.3×Si−5.4×Mn+75×P+190×S−14×Al+45×Nb−1, and (3)
PTI=Ti−1.5×(O−0.89×Al)−3.4×N−4.5×S, (4)
wherein symbols of elements on the right-hand side of each formula represent contents of the elements (% by mass), respectively, and a content of an element not contained is set to 0, the method comprising:
hot-rolling a slab and thereafter cooling the hot-rolled slab to 400° C. or lower at a cooling rate of 2° C./s or less to produce a thick steel plate;
cold-working the thick steel plate into a tubular shape; and
subjecting the resultant thick steel plate to butt welding.

6. The method of producing the abrasion resistant welded steel pipe according to claim 5, wherein the butt welding is performed by submerged arc welding.

7. The abrasion resistant welded steel pipe according to claim 2, wherein the base material of the abrasion resistant welded steel pipe has a metallographic structure including: a matrix structure including a ferrite structure and a pearlite structure; and a hard phase dispersed in the matrix structure.

8. The abrasion resistant welded steel pipe according to claim 7, wherein a dispersion density of the hard phase is 400 grains/mm² or more.

9. The method of producing the abrasion resistant welded steel pipe according to claim 5, wherein the chemical composition of at least one of the base material and the weld metal of the abrasion resistant welded steel pipe include, in terms of percent by mass, at least one selected from Nb: 0.005% or more and 1.000% or less and V: 0.005% or more and 1.000% or less.

10. The method of producing the abrasion resistant welded steel pipe according to claim 5, wherein the base material of the abrasion resistant welded steel pipe has a metallographic structure including: a matrix structure including a ferrite structure and a pearlite structure; and a hard phase dispersed in the matrix structure.

11. The method of producing the abrasion resistant welded steel pipe according to claim 10, wherein a dispersion density of the hard phase is 400 grains/mm² or more.

12. The method of producing the abrasion resistant welded steel pipe according to claim 9, wherein the base material of the abrasion resistant welded steel pipe has a metallographic structure including: a matrix structure including a ferrite structure and a pearlite structure; and a hard phase dispersed in the matrix structure.

13. The method of producing the abrasion resistant welded steel pipe according to claim 12, wherein a dispersion density of the hard phase is 400 grains/mm² or more.

14. The method of producing the abrasion resistant welded steel pipe according to claim 9, wherein the butt welding is performed by submerged arc welding.

15. The method of producing the abrasion resistant welded steel pipe according to claim 10, wherein the butt welding is performed by submerged arc welding.

16. The method of producing the abrasion resistant welded steel pipe according to claim 11, wherein the butt welding is performed by submerged arc welding.

17. The method of producing the abrasion resistant welded steel pipe according to claim 12, wherein the butt welding is performed by submerged arc welding.

18. The method of producing the abrasion resistant welded steel pipe according to claim 13, wherein the butt welding is performed by submerged arc welding.
